(19) United States
(12) Patent Application Publication
(10) Pub. No.: US 2024/0094455 A1
(43) Pub. Date: Mar. 21, 2024

(54) Wave Plate Arrangements for an Optical System

(71) Applicant: Apple Inc., Cupertino, CA (US)

(72) Inventors: Jin Yan, San Jose, CA (US); Young Cheol Yang, Sunnyvale, CA (US); Zhibing Ge, Sunnyvale, CA (US)

(21) Appl. No.: 18/261,981

(22) PCT Filed: Jan. 11, 2022
(86) PCT No.: PCT/US2022/011954

§ 371 Date: Jul. 18, 2023

Related U.S. Application Data
(60) Provisional application No. 63/144,377, filed on Feb. 1, 2021.

(51) Int. Cl. G02B 5/30; G02B 27/00; G02B 27/01; G02B 27/09; G02B 27/28

(52) U.S. Cl. CPC G02B 5/3083; G02B 27/0018; G02B 27/0172; G02B 27/0955; G02B 27/0977; G02B 27/286; G02B 2027/0116

(57) ABSTRACT

An electronic device may include a display system and an optical system that are supported by a housing. The optical system may be a catadioptric optical system having one or more lens elements. The optical system may include a wave plate stack with one or more wave plates. The display system may include a polarizer stack with a linear polarizer and one or more wave plates. The optical system and display system may each include a negative dispersion quarter wave plate. A positive C-plate may be positioned adjacent to each quarter wave plate. The optical system may include a quarter wave plate having positive birefringence whereas the display system may include a quarter wave plate having negative birefringence. The optical system and display system may each include a quarter wave plate and a half wave plate.

This application claims priority to U.S. provisional patent application No. 63/144,377, filed Feb. 1, 2021, which is hereby incorporated by reference herein in its entirety.

### BACKGROUND

This relates generally to optical systems and, more particularly, to optical systems for head-mounted devices.

Head-mounted devices such as virtual reality glasses use lenses to display images for a user. A microdisplay may create images for each of a user's eyes. A lens may be placed between each of the user's eyes and a portion of the microdisplay so that the user may view virtual reality content.

### SUMMARY

An electronic device may include a display system and an optical system. The display system and optical system may be supported by a housing that is worn on a user's head. The electronic device may use the display system and optical system to present images to the user while the housing is being worn on the user's head.

The display system may have a pixel array that produces image light associated with the images. The display system may also have a linear polarizer through which image light from the pixel array passes and one or more wave plates through which the light passes after passing through the linear polarizer.

The optical system may be a catadioptric optical system having one or more lens elements. The optical system may include one or more wave plates. The optical system and display system may each include a negative dispersion quarter wave plate. A positive C-plate may be positioned adjacent to each quarter wave plate. The optical axes of the negative dispersion quarter wave plates may be perpendicular.

The optical system may include a quarter wave plate having positive birefringence whereas the display system may include a quarter wave plate having negative birefringence. The optical axes of the positive birefringence quarter wave plate and the negative birefringence quarter wave plate may be parallel.

The optical system and display system may each include a quarter wave plate and a half wave plate. In one example, the quarter wave plate in the display system has a negative birefringence, the half wave plate in the display system has a positive birefringence, the quarter wave plate in the optical system has a positive birefringence, and the half wave plate in the optical system has a negative birefringence. The quarter wave plates may have parallel optical axes and the half wave plates may have parallel optical axes.

In another example, the quarter wave plate in the display system has a positive birefringence, the half wave plate in the display system has a positive birefringence, the quarter wave plate in the optical system has a positive birefringence, and the half wave plate in the optical system has a positive birefringence. The quarter wave plates may have perpendicular optical axes and the half wave plates may have perpendicular optical axes.

### BRIEF DESCRIPTION OF THE DRAWINGS

FIG. 1 is a diagram of an illustrative head-mounted device in accordance with an embodiment.

FIG. 2 is a diagram of an illustrative head-mounted device showing components of an illustrative optical system in the head-mounted device in accordance with an embodiment.

FIG. 3 is a cross-sectional side view of an illustrative head-mounted device showing how the polarization of light changes when passing through the optical system of FIG. 2 in accordance with an embodiment.

FIG. 4 is a cross-sectional side view of an illustrative wave plate stack for an optical system that includes a negative dispersion quarter wave plate and an illustrative polarizer stack for a display system that includes a negative dispersion quarter wave plate in accordance with an embodiment.

FIG. 5 is a cross-sectional side view of an illustrative wave plate stack for an optical system that includes a +A quarter wave plate and an illustrative polarizer stack for a display system that includes a −A quarter wave plate in accordance with an embodiment.

FIG. 6 is a cross-sectional side view of an illustrative wave plate stack for an optical system that includes a −A half wave plate and a +A quarter wave plate and an illustrative polarizer stack for a display system that includes a −A quarter wave plate and a +A half wave plate in accordance with an embodiment.

FIG. 7 is a cross-sectional side view of an illustrative wave plate stack for an optical system that includes a +A half wave plate and a +A quarter wave plate and an illustrative polarizer stack for a display system that includes a +A quarter wave plate and a +A half wave plate in accordance with an embodiment.

FIG. 8 is a cross-sectional side view of an illustrative liquid crystal display system that includes a liquid crystal display panel between a front linear polarizer and a rear linear polarizer and a negative dispersion quarter wave plate above the front linear polarizer in accordance with an embodiment.

FIG. 9 is a cross-sectional side view of an illustrative liquid crystal display system that includes a liquid crystal display panel between a front linear polarizer and a rear linear polarizer and a polarization compensating layer between the front linear polarizer and the liquid crystal display panel.

### DETAILED DESCRIPTION

Head-mounted devices may be used for virtual reality and augmented reality systems. For example, a pair of virtual reality glasses that is worn on the head of a user may be used to provide a user with virtual reality content and/or augmented reality content.

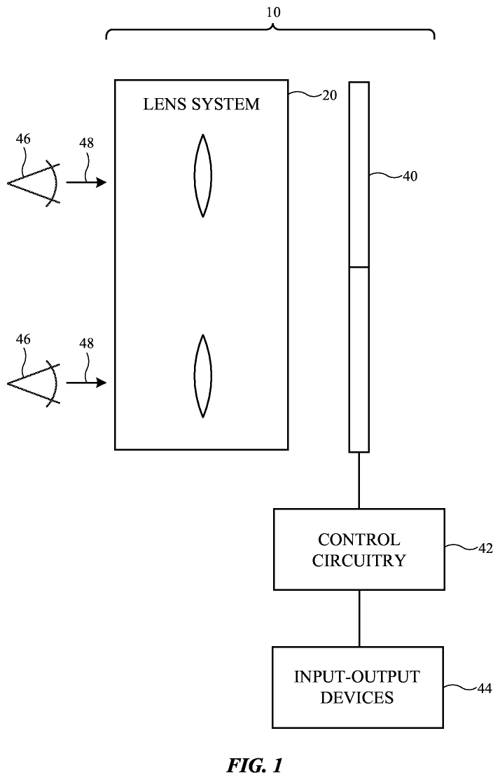

An illustrative system in which an electronic device (e.g., a head-mounted device such as a pair of virtual reality glasses) is used in providing a user with virtual reality content is shown in FIG. 1. As shown in FIG. 1, virtual reality glasses 10 (sometimes referred to as glasses 10, electronic device 10, head-mounted device 10, head-mounted display 10, etc.) may include a display system such as display system 40 that creates images and may have an optical system such as optical system 20 through which a user (see, e.g., user's eyes 46) may view the images produced by display system 40 by looking in direction 48.

Display system 40 (sometimes referred to as display panel 40 or display 40) may be based on a liquid crystal display, an organic light-emitting diode display, an emissive display having an array of crystalline semiconductor light-emitting diode dies, and/or displays based on other display technologies. Separate left and right displays may be included in system 40 for the user's left and right eyes or a single display may span both eyes.

Visual content (e.g., image data for still and/or moving images) may be provided to display system (display) 40 using control circuitry 42 that is mounted in glasses (head-mounted device) 10 and/or control circuitry that is mounted outside of device 10 (e.g., in an associated portable electronic device, laptop computer, or other computing equipment). Control circuitry 42 may include storage such as hard-disk storage, volatile and non-volatile memory, electrically programmable storage for forming a solid-state drive, and other memory. Control circuitry 42 may also include one or more microprocessors, microcontrollers, digital signal processors, graphics processors, baseband processors, application-specific integrated circuits, and other processing circuitry. Communications circuits in circuitry 42 may be used to transmit and receive data (e.g., wirelessly and/or over wired paths). Control circuitry 42 may use display system 40 to display visual content such as virtual reality content (e.g., computer-generated content associated with a virtual world), pre-recorded video for a movie or other media, or other images. Illustrative configurations in which control circuitry 42 provides a user with virtual reality content using display system 40 may sometimes be described herein as an example. In general, however, any suitable content may be presented to a user by control circuitry 42 using display system 40 and optical system 20 of device 10.

Input-output devices 44 may be coupled to control circuitry 42. Input-output devices 44 may be used to gather user input from a user, may be used to make measurements on the environment surrounding device 10, may be used to provide output to a user, and/or may be used to supply output to external electronic equipment. Input-output devices 44 may include buttons, joysticks, keypads, keyboard keys, touch sensors, track pads, displays, touch screen displays, microphones, speakers, light-emitting diodes for providing a user with visual output, sensors (e.g., a force sensors, temperature sensors, magnetic sensor, accelerometers, gyroscopes, and/or other sensors for measuring orientation, position, and/or movement of device 10, proximity sensors, capacitive touch sensors, strain gauges, gas sensors, pressure sensors, ambient light sensors, and/or other sensors). If desired, input-output devices 44 may include one or more cameras (e.g., cameras for capturing images of the user's surroundings, cameras for performing gaze detection operations by viewing eyes 46, and/or other cameras).

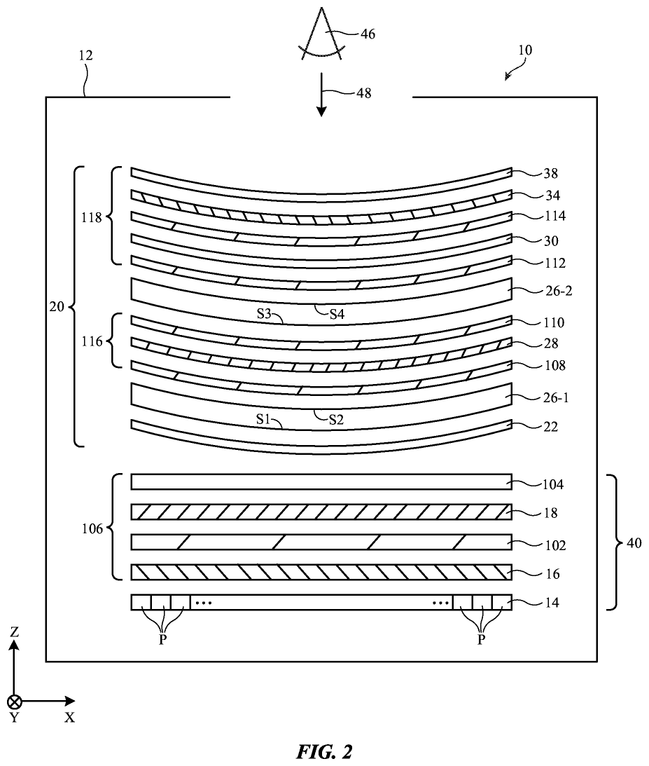

FIG. 2 is a cross-sectional side view of device 10 showing how optical system 20 and display system 40 may be supported by head-mounted support structures such as housing 12 for device 10. Housing 12 may have the shape of a frame for a pair of glasses (e.g., device 10 may resemble eyeglasses), may have the shape of a helmet (e.g., device 10 may form a helmet-mounted display), may have the shape of a pair of goggles, or may have any other suitable housing shape that allows housing 12 to be worn on the head of a user. Configurations in which housing 12 supports optical system 20 and display system 40 in front of a user's eyes (e.g., eyes 46) as the user is viewing system 20 and display system 40 in direction 48 may sometimes be described herein as an example. If desired, housing 12 may have other desired configurations.

Housing 12 may be formed from plastic, metal, fiber-composite materials such as carbon-fiber materials, wood and other natural materials, glass, other materials, and/or combinations of two or more of these materials.

Input-output devices 44 and control circuitry 42 may be mounted in housing 12 with optical system 20 and display system 40 and/or portions of input-output devices 44 and control circuitry 42 may be coupled to device 10 using a cable, wireless connection, or other signal paths.

Display system 40 and the optical components of device 10 may be configured to display images for user 46 using a lightweight and compact arrangement. Optical system 20 may, for example, be based on catadioptric lenses (e.g., lenses that use both reflecting and refracting of light). There may be one lens stack (e.g., optical system 20 in FIG. 2) aligned with each eye of the user while the user wears device 10.

Display system 40 may include a source of images such as pixel array 14. Pixel array 14 may include a two-dimensional array of pixels P that emits image light (e.g., organic light-emitting diode pixels, light-emitting diode pixels formed from semiconductor dies, liquid crystal display pixels with a backlight, liquid-crystal-on-silicon pixels with a frontlight, etc.). A polarizer such as linear polarizer 16 may be placed in front of pixel array 14 and/or may be laminated to pixel array 14 to provide polarized image light. Linear polarizer 16 may have a pass axis aligned with the X-axis of FIG. 2 (as an example). Display system 40 may also include a wave plate such as quarter wave plate 18 to provide circularly polarized image light. The optical axis (fast axis) of quarter wave plate 18 may be aligned at 45 degrees relative to the pass axis of linear polarizer 16. Quarter wave plate 18 may be mounted in front of polarizer 16 (between polarizer 16 and optical system 20). If desired, quarter wave plate 18 may be attached to polarizer 16 (and display 14) with an adhesive layer such as adhesive 102.

Adhesive layer 102 may be an optically clear adhesive (OCA) layer such as a liquid optically clear adhesive (LOCA) layer. The optically clear adhesive layer 102 may have a high transparency (greater than 80%, greater than 90%, greater than 95%, greater than 99%, greater than 99.9%, etc.) to avoid reducing the efficiency of the system.

An anti-reflective coating 104 may be formed over quarter wave plate 18. Anti-reflective coating 104 (sometimes referred to as coatings 104 or anti-reflective layer 104) may mitigate undesired reflections of ambient light within the system, as one example.

Linear polarizer 16, adhesive layer 102, quarter wave plate 18, and anti-reflective layer 104 may collectively be referred to as a display polarizer stack 106. Display system 40 therefore includes pixel array 14 that is covered by display polarizer stack 106 (sometimes referred to as polarizer stack 106, optical layers 106, etc.).

Optical system 20 may include one or more lens elements such as lens elements 26-1 and 26-2. Each lens element may be formed from a transparent material such as plastic or glass. Lens element 26-1 may have a surface S1 that faces display system 40 and a surface S2 that faces the user (e.g. eyes 46). Lens element 26-2 may have a surface S3 that faces display system 40 and a surface S4 that faces the user. Each one of surfaces S1, S2, S3, and S4 may be a convex surface (e.g., a spherically convex surface, a cylindrically convex surface, or an aspherically convex surface) or a concave surface (e.g., a spherically concave surface, a cylindrically concave surface, or an aspherically concave surface). A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In one illustrative arrangement shown in FIG. 2, surface S1 has convex curvature, surface S2 has concave curvature, surface S3 has convex curvature, and surface S4 has concave curvature. As an example, surface S2 may be cylindrically concave and surface S3 may be cylindrically convex (e.g., surfaces S2 and S3 may be mating cylindrical surfaces). Surface S4 may have aspheric concave curvature.

The example of two lens elements being used in FIG. 2 is merely illustrative. If desired, the optical system may include only one lens element, two lens elements, three lens elements, more than three elements, etc.

Optical structures such as partially reflective coatings, wave plates, reflective polarizers, linear polarizers, antireflection coatings, and/or other optical components may be incorporated into device 10 (e.g., system 20, etc.). These optical structures may allow light rays from display system 40 to pass through and/or reflect from surfaces in optical system 20, thereby providing optical system 20 with a desired lens power.

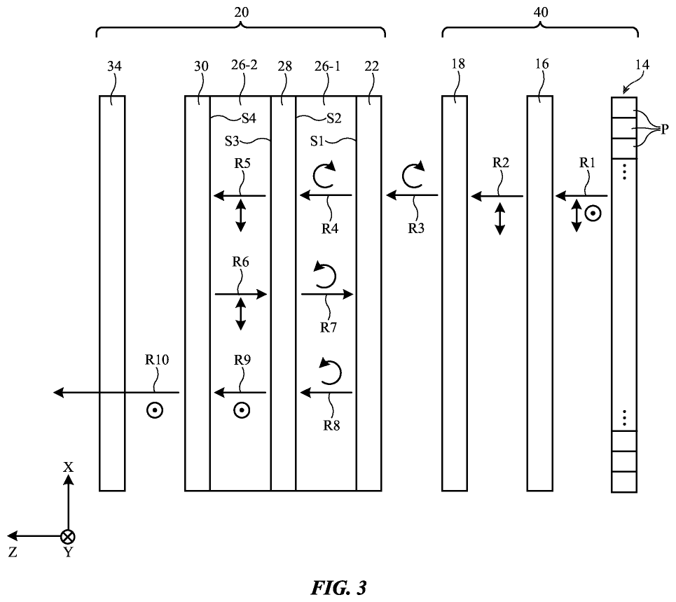

An illustrative arrangement for the optical layers is shown in FIG. 2. First, the structural arrangement of these layers will be described. The functionality of these layers will be discussed in more detail in connection with FIG. 3.

As shown in FIG. 2, a partially reflective mirror (e.g., a metal mirror coating or other mirror coating such as a dielectric multilayer coating with a 50% transmission and a 50% reflection) such as partially reflective mirror 22 may be formed on the convex surface S1 (e.g., an aspheric convex surface) of lens element 26-1. Partially reflective mirror 22 may sometimes be referred to as beam splitter 22, half mirror 22, or partially reflective layer 22. Partially reflective mirror 22 may transmit between 20% and 80% of light, between 30% and 70% of light, between 40% and 60% of light, between 45% and 55% of light, etc. Partially reflective mirror 22 may reflect between 20% and 80% of light, between 30% and 70% of light, between 40% and 60% of light, between 45% and 55% of light, etc.

A wave plate such as wave plate 28 may be formed on the concave surface S2 of lens element 26-1. Wave plate 28 (sometimes referred to as retarder 28, quarter wave plate 28, etc.) may be a quarter wave plate that conforms to surface S2 of lens element 26. Retarder 28 may be attached to lens element 26-1 using an adhesive layer 108 (as shown in FIG. 2). In another possible arrangement, retarder 28 may be a coating on surface S2 of lens element 26-1. Retarder 28 may instead be formed on surface S1 of lens element 26-1 if desired. In yet another embodiment, first and second retarder coatings may be formed on surfaces S1 and S2 of lens element 26-1, with the first and second retarder coatings collectively forming a quarter wave plate.

An additional adhesive layer 110 may attach quarter wave plate 28 to surface S3 of lens element 26-2. An adhesive layer 112 couples reflective polarizer 30 to surface S4 of lens element 26-2. Reflective polarizer 30 may have orthogonal reflection and pass axes. Light that is polarized parallel to the reflection axis of reflective polarizer 30 will be reflected by reflective polarizer 30. Light that is polarized perpendicular to the reflection axis and therefore parallel to the pass axis of reflective polarizer 30 will pass through reflective polarizer 30.

Linear polarizer 34 may be attached to reflective polarizer 30 using adhesive layer 114. Polarizer 34 may sometimes be referred to as an external blocking linear polarizer 34. Linear polarizer 34 may have a pass axis aligned with the pass axis of reflective polarizer 30. Linear polarizer 34 may have a pass axis that is orthogonal to the pass axis of linear polarizer 16.

One or more additional coatings 38 may also be included in optical system 20 (sometimes referred to as lens 20, lens assembly 20, or lens module 20). Coatings 38 may include an anti-reflective coating (ARC), anti-smudge (AS) coating, or any other desired coatings.

The adhesive layers 108, 110, 112, and 114 may be optically clear adhesive (OCA) layers such as liquid optically clear adhesive (LOCA) layers. The optically clear adhesive layers may have a high transparency (greater than 80%, greater than 90%, greater than 95%, greater than 99%, greater than 99.9%, etc.) to avoid reducing the efficiency of the system.

FIG. 3 is a cross-sectional side view of an illustrative optical system 20 and display system 40 showing how light from the display passes through the optical system of FIG. 2. Note that the adhesive layers as well as coatings 38 and 104 are not shown in FIG. 3 since these layers do not appreciably impact the polarization of light travelling through the system. As shown in FIG. 3, a light ray R1 may be emitted from display 14. Light ray R1 exits display 14 having a mix of polarization states. As image light ray R1 exits display 14 and passes through linear polarizer 16, ray R1 becomes linearly polarized in alignment with the pass axis of linear polarizer 16. The pass axis of linear polarizer 16 may be, for example, aligned with the X-axis of FIG. 3. After passing through polarizer 16, ray R2 passes through wave plate 18, which may be a quarter wave plate. As ray R2 passes through quarter wave plate 18, ray R3 exits the quarter wave plate circularly polarized (e.g., with a clockwise circular polarization).

When circularly polarized ray R3 strikes partially reflective mirror 22, a portion of ray R3 will pass through partially reflective mirror 22 to become reduced-intensity ray R4. Ray R4 will be refracted (partially focused) by the shape of convex surface S1 of lens element 26-1. It should be noted that the depiction of surfaces of S1, S2, S3, and S4 as planar in FIG. 3 are merely illustrative. In practice, surfaces S1, S2, S3, and S4 may be curved as shown and discussed in connection with FIG. 2.

Wave plate 28 may convert the circular polarization of ray R4 into linear polarization. Quarter wave plate 28 may, for example, convert circularly polarized ray R4 into a ray R5 with a linear polarization aligned with the X-axis of FIG. 2. Ray R5 may optionally be refracted (partially focused) by the shape of surface S3 of lens element 26-2 and/or the shape of surface S2 of lens element 26-1. Quarter wave plate 28 in optical system 20 may be rotated 90 degrees relative to quarter wave plate 18 in display 40 (e.g., the fast axes of quarter wave plates 18 and 28 are orthogonal). Other arrangements for quarter wave plates 28 and 18 may be used, as will be discussed later in greater detail.

As previously mentioned, reflective polarizer 30 may have orthogonal reflection and pass axes. Light that is polarized parallel to the reflection axis of reflective polarizer 30 will be reflected by reflective polarizer 30. Light that is polarized perpendicular to the reflection axis and therefore parallel to the pass axis of reflective polarizer 30 will pass through reflective polarizer 30. In the illustrative arrangement of FIG. 3, reflective polarizer 30 has a reflection axis that is aligned with the X-axis and a pass axis that is aligned with the Y-axis, so ray R5 will reflect from reflective polarizer 30 as reflected ray R6. It should be noted that the pass axis of reflective polarizer 30 is orthogonal to the pass axis of linear polarizer 16 in display system 40.

Reflected ray R6 has a linear polarization aligned with the X-axis. After passing through quarter wave plate 28, the linear polarization of ray R6 will be converted into circular polarization (i.e., ray R6 will become counter-clockwise circularly polarized ray R7).

Circularly polarized ray R7 will travel through lens element 26-1 and a portion of ray R7 will be reflected in the positive Z direction by the partially reflective mirror 22 on the convex surface S1 of lens element 26-1 as reflected ray R8. The reflection from the curved shape of surface S1 provides optical system 20 with additional optical power.

Ray R8 from partially reflective mirror 22 is converted from circularly polarized light to linearly polarized light ray R9 by quarter wave plate 28. Passing through the curved surface S4 of lens element 26-2 may provide optical system 20 with additional optical power (e.g., refractive optical power). The linear polarization of ray R9 is aligned with the Y-axis, which is parallel to the pass axis of reflective polarizer 30. Accordingly, ray R9 will pass through reflective polarizer 30 as ray R10 to provide a viewable image to the user.

Linear polarizer 34 has a pass axis aligned with the pass axis of reflective polarizer 30 (i.e., parallel to the Y-axis in this example) so that any light from the external environment will be polarized by linear polarizer 34 such that light is not reflected by the reflective polarizer 30. Ambient light (e.g., light not from pixel array 14) that is transmitted by the linear polarizer 34 and the reflective polarizer 30 will pass through retarders 28 and 18 and be absorbed by linear polarizer 16. Linear polarizer 34 has a pass axis (parallel to the Y-axis) that is orthogonal to the pass axis (parallel to the X-axis) of linear polarizer 16 in the display.

The optical system 20 may be formed as a single, solid lens assembly without any intervening air gaps. The retardation provided by retarder 28 across the entire retarder may be uniform within 20%, within 10%, within 5%, within 3%, within 2%, within 1%, etc. Similarly, the thickness 62 of retarder 28 across the entire retarder may be uniform within 20%, within 10%, within 5%, within 3%, within 2%, within 1%, etc. In other words, the retardation variation across the retarder is no more than 20%, no more than 10%, no more than 5%, no more than 3%, no more than 2%, no more than 1%, etc. The thickness variation across the retarder is no more than 20%, no more than 10%, no more than 5%, no more than 3%, no more than 2%, no more than 1%, etc.

Retarder 28 may be formed from any desired materials using any desired processes. As one example, retarder 28 may be formed from a liquid crystal material that is deposited over a photo-aligned alignment layer. As another example, retarder 28 may be formed from a liquid crystal material that is aligned using shear alignment. As yet another example, retarder 28 may be formed from an inorganic material using oblique deposition. The materials for retarder 28 may be deposited using spin coating, die coating, spray coating, physical vapor deposition (PVD), or any other desired techniques. As another example, retarder 28 may be formed by a polymer film that is stretched along one axis to induce birefringence.

The example of a material having a uniform birefringence and relatively uniform birefringence being used to form the retarder is merely illustrative. Any type of retarder that provides uniform retardation may be used. As one example, the retarder may have a first thickness and a first birefringence in a first portion. The retarder may have a second thickness and a second birefringence in a second portion. The second birefringence may be different than the first birefringence and the second thickness may be different than the first thickness. However, the retardation may be the same in both portions. In other words, the retarder may be provided with different birefringence in different portions that are compensated by different thicknesses in the different portions to provide uniform retardation. These types of techniques may be used to provide uniform retardation even when uniform thickness is not practical from a manufacturing standpoint.

Adhesive layer 108, quarter wave plate 28, and adhesive layer 110 may collectively be referred to as quarter wave plate stack 116, wave plate stack 116, or retarder stack 116. Adhesive layer 112, reflective polarizer 30, adhesive layer 114, linear polarizer 34, and anti-reflective coating 38 may collectively be referred to as the lens polarizer stack 118.

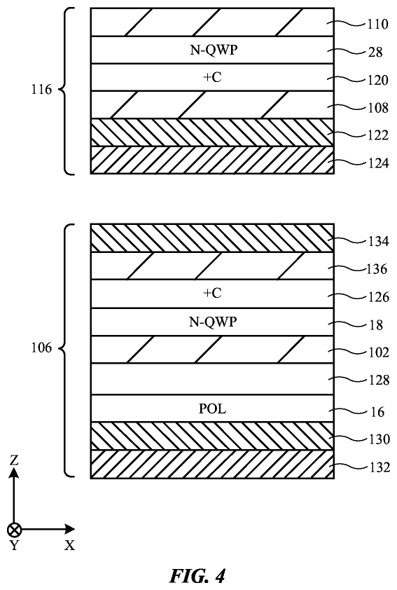

The display polarizer stack 106, lens polarizer stack 118, and lens quarter wave plate stack 116 may be designed to accurately control the polarization state of light. Otherwise, undesired light paths may create stray light or ghost images, thereby degrading the image quality. One example of an undesired light path is the direct leakage of R5 passing through reflective polarizer 30 and linear polarizer 34 (e.g., if R5 contains a portion of light polarized along the Y-axis). Other examples include light R9 being reflected one or two more times from the reflective polarizer before passing through the polarizer 34 towards the user. To minimize the intensity of light following these undesired light paths, the optical system may include broadband and wide field-of-view wave plate designs. Some specific examples of display polarizer stack 106 and lens quarter wave plate stack 116 that mitigate the intensity of the undesired light are shown in FIGS. 4-7.

FIG. 4 is a cross-sectional side view showing possible arrangements for wave plate stack 116 in optical system 20 and polarizer stack 106 in display system 40. Wave plate stack 116 and polarizer stack 106 may work in combination to manipulate light in a desired manner (e.g., as shown in connection with FIG. 3).

In one possible arrangement, shown in FIG. 4, wave plate stack 116 includes a negative dispersion quarter wave plate (N-QWP) 28. A negative dispersion material has a reverse birefringence dispersion, with the magnitude of birefringence (Δn) increasing with increasing wavelength. In contrast, in positive dispersion materials, a magnitude of birefringence decreases with increasing wavelength. Quarter wave plate 28 in FIG. 4 is formed from a material having a negative dispersion (sometimes referred to as a negative dispersion material).

The quarter wave plate may, ideally, produce a phase retardation of π/2 across the visible light spectrum. Using a negative dispersion quarter wave plate as in FIG. 4 may improve wave plate dispersion and provide the desired phase retardation across the full visible light wavelength range (e.g., broadband performance).

In addition to N-QWP 28, wave plate stack 116 includes a positive C-plate 120 (sometimes referred to as +C plate, posi-C plate, etc.). Quarter wave plate 28 may be an A-plate. A-plates have an optical axis (e.g., parallel to the extraordinary axis of the wave plate) that is parallel to the plane of the plate (e.g., within the XY-plane in FIG. 4). In contrast, C-plates have an optical axis that is perpendicular to the plane of the plate (e.g., parallel to the Z-axis of FIG. 4). In a positive C-plate, the refractive index along the Z-axis (e.g., orthogonal to the plane of the plate) is larger than refractive indices along the X and Y axes (e.g., within the plane of the plate). In a negative C-plate, the refractive index along the Z-axis (e.g., orthogonal to the plane of the plate) is smaller than refractive indices along the X and Y axes (e.g., within the plane of the plate). In both positive C-plates and negative C-plates, the refractive index along the X-axis is equal to the refractive index along the Y-axis.

The +C plate 120 in FIG. 4 compensates for the viewing angle dependence of quarter wave plate 28. By including the +C plate, the display has more brightness and color uniformity across viewing angles.

In FIG. 4, negative dispersion quarter wave plate 28 and positive C-plate 120 are interposed between adhesive layers 108 and 110. The wave plate stack 116 also includes a substrate 122 and a hard coating 124. Substrate 122 may be formed from a polymer material such as triacetyl cellulose (TAC) or any other desired material. Hard coating 124 may protect the wave plate stack and/or other components in optical system 20 from damage during assembly and operation of the optical system. Each hard coating described herein may be a thermally cured or UV cured hard coating, as two examples.

Quarter wave plate 18 in polarizer stack 106 is also a negative dispersion quarter wave plate. Similar to the wave plate stack 116, polarizer stack 106 also includes a positive C-plate 126 adjacent to quarter wave plate 18. The +C plate 126 in FIG. 4 compensates for the viewing angle dependence of quarter wave plate 18.

An adhesive layer 102 is interposed between N-QWP 18 and linear polarizer 16. One or more compensating layers 128 may also be formed between N-QWP 18 and linear polarizer 16. Compensating layers 128 may perform polarization compensation to ensure light having desired polarization reaches N-QWP 18 at off-axis angles. The polarizer stack 116 also includes a substrate 130 and a hard coating 132. Polarizer 16 is interposed between N-QWP 18 and substrate 130. Substrate 130 is interposed between polarizer 16 and hard coating 132. Substrate 130 may be formed from a polymer material such as triacetyl cellulose (TAC) or any other desired material. Hard coating 132 may protect the polarizer stack and/or other components in display system 20 from damage during assembly and operation of the display system. The polarizer stack 116 also includes a substrate 134 and an adhesive layer 136. Adhesive layer 136 is interposed between positive C-plate 126 and substrate 134. Substrate 134 may be formed from a polymer material such as triacetyl cellulose (TAC) or any other desired material.

Each layer in wave plate stack 116 and polarizer stack 106 (except the linear polarizer 16) may have a high transparency (greater than 80%, greater than 90%, greater than 95%, greater than 99%, greater than 99.9%, etc.) to avoid reducing the efficiency of the system.

The absorption axes and optical axes of the components (e.g., linear polarizer 16 and wave plates 18 and 28) may be selected to optimize performance of the system. In FIG. 4, wave plate 18 may have an optical axis that is perpendicular to the optical axis of wave plate 28. In other words, the wave plate optical axes are orthogonal. The optical axis of quarter wave plate 18 may be at a 45 degree angle relative to the absorption axis of linear polarizer 16. This means that, necessarily, the optical axis of quarter wave plate 18 is also at a 45 degree angle relative to the pass axis of linear polarizer 16 and the optical axis of quarter wave plate 28 is at a 45 degree angle relative to the absorption axis of linear polarizer 16. As discussed in connection with FIGS. 2 and 3, the reflection axis of the reflective polarizer in the optical system may be orthogonal to the absorption axis of linear polarizer 16. Therefore, the optical axis of quarter wave plate 18 is also at a 45 degree angle relative to the reflection axis of reflective polarizer 30. The optical axis of quarter wave plate 28 is also at a 45 degree angle relative to the reflection axis of reflective polarizer 30. The display N-QWP 18 may have an optical axis at a −45 degree angle relative to the absorption axis of linear polarizer 16. In this case, the lens N-QWP 28 may have an optical axis at a +45 degree angle relative to the absorption axis of linear polarizer 16.

The examples of wave plate stack 116 and polarizer stack 106 in FIG. 4 are merely illustrative. In general, various layers (e.g., adhesive layers, hard coatings, substrates, compensating layers, etc.) may be omitted or added to the stacks as desired. Additionally, other arrangements for the wave plates themselves may be used.

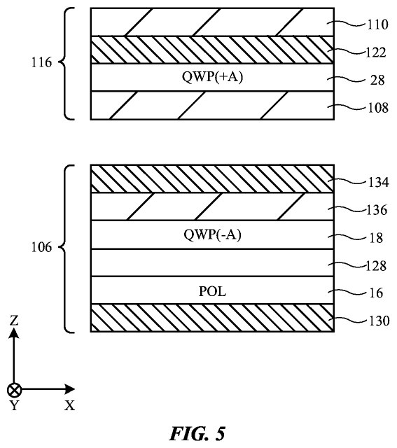

FIG. 5 shows an example where wave plate stack 116 includes a normal dispersion quarter wave plate 28. The quarter wave plate 28 is a positive A-plate (sometimes referred to as +A plate 28, +A QWP 28, etc.). The polarizer stack 106, meanwhile, includes a normal dispersion quarter wave plate that is a negative A-plate (sometimes referred to as −A plate 18, −A QWP 18, etc.).

A positive A-plate has positive birefringence (e.g., the extraordinary index of refraction is greater than the ordinary index of refraction) whereas a negative A-plate has negative birefringence (e.g., the extraordinary index of refraction is less than the ordinary index of refraction). In other words, QWP 28 has a birefringence of the opposite sign as QWP 18.

The optical axes of +A plate 28 and −A plate 18 are parallel. The optical axis of quarter wave plate 18 may be at a 45 degree angle relative to the absorption axis of linear polarizer 16. This means that, necessarily, the optical axis of quarter wave plate 18 is also at a 45 degree angle relative to the pass axis of linear polarizer 16 and the optical axis of quarter wave plate 28 is at a 45 degree angle relative to the absorption axis of linear polarizer 16. The optical axis of quarter wave plate 18 is also at a 45 degree angle relative to the reflection axis of reflective polarizer 30. The optical axis of quarter wave plate 28 is also at a 45 degree angle relative to the reflection axis of reflective polarizer 30. The display −A QWP 18 may have an optical axis at a +45 degree angle relative to the absorption axis of linear polarizer 16. In this case, the lens +A QWP 28 may also have an optical axis at a +45 degree angle relative to the absorption axis of linear polarizer 16.

In FIG. 5, +A QWP 28 is interposed between adhesive layer 108 and substrate 122. Substrate 122 is interposed between QWP 28 and adhesive layer 110. In the polarizer stack 106, polarization compensating layer(s) 128 are interposed between −A QWP 18 and linear polarizer 16. QWP 18 is also attached to adhesive layer 136, which is interposed between QWP 18 and substrate 134. Substrate 130 is also included adjacent to polarizer 16.

A wave plate arrangement of the type shown in FIG. 5 may increase viewing angle uniformity for the system. The examples of wave plate stack 116 and polarizer stack 106 in FIG. 5 are merely illustrative. In general, various layers (e.g., adhesive layers, hard coatings, substrates, compensating layers, etc.) may be omitted or added to the stacks as desired.

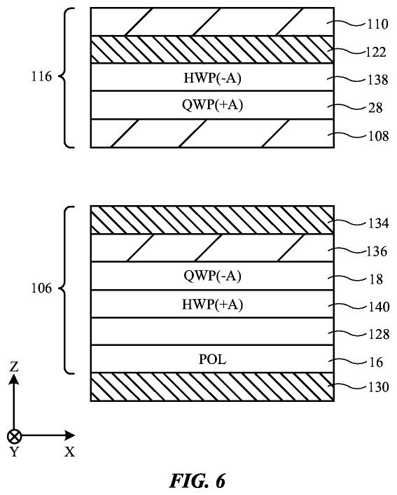

FIG. 6 shows an example where wave plate stack 116 includes a normal dispersion, positive birefringence +A quarter wave plate 28. The quarter wave plate 28 is a positive A-plate (sometimes referred to as +A plate 28, +A QWP 28, etc.). The wave plate stack 116 also includes a normal dispersion half wave plate (HWP) 138. The half wave plate 138 is a negative A-plate (e.g., the half wave plate has negative birefringence). In contrast to a quarter wave plate (which produces a phase retardation of π/2), the half wave plate produces a phase retardation of 7E.

The polarizer stack 106, meanwhile, includes a normal dispersion quarter wave plate that is a negative A-plate (sometimes referred to as −A plate 18, −A QWP 18, etc.). QWP 18 has a negative birefringence. Polarizer stack 106 also includes a normal dispersion half wave plate (HWP) 140. The half wave plate 140 is a positive A-plate (e.g., the half wave plate has positive birefringence).

In other words, QWP 18 has a birefringence of the opposite sign (type) as HWP 140. QWP 28 has a birefringence of the opposite sign as HWP 138. QWP 28 has a birefringence of the same sign as HWP 140. QWP 28 has a birefringence of the opposite sign as QWP 18.

The optical axes of QWPs 18 and 28 as well as HWPs 138 and 140 may be selected such that the HWPs compensate for the QWPs. The optical axes of +A QWP 28 and −A QWP 18 may be parallel. The optical axes of −A HWP 138 and +A HWP 140 may be parallel. The angles of the optical axes relative to the absorption axis of linear polarizer 16 may satisfy the equation |β−2α|=π/4, 3π/4, 5π/4, . . . where β is the angle of the optical axes of the QWPs and a is the angle of the optical axes of the HWPs. In one example, QWP 28 has an optical axis at an angle of −75 degrees relative to the absorption axis of polarizer 16, HWP 138 has an optical axis at an angle of +75 degrees relative to the absorption axis of polarizer 16, QWP 18 has an optical axis at an angle of −75 degrees relative to the absorption axis of polarizer 16, and HWP 140 has an optical axis at an angle of +75 degrees relative to the absorption axis of polarizer 16. Using these angles satisfies the aforementioned equation (e.g., abs(−75°−2*(+75°=225°=5π/4).

In FIG. 6, +A QWP 28 and −A HWP 138 are interposed between adhesive layer 108 and substrate 122. Substrate 122 is interposed between HWP 138 and adhesive layer 110. In display polarizer stack 106, compensating layer(s) 128 are interposed between +A HWP 140 and linear polarizer 16. QWP 18 is also attached to adhesive layer 136, which is interposed between QWP 18 and substrate 134. Substrate 130 is also included adjacent to polarizer 16.

A wave plate arrangement of the type shown in FIG. 6 may increase viewing angle uniformity for the system while also providing broadband performance. The examples of wave plate stack 116 and polarizer stack 106 in FIG. 6 are merely illustrative. In general, various layers (e.g., adhesive layers, hard coatings, substrates, compensating layers, etc.) may be omitted or added to the stacks as desired.

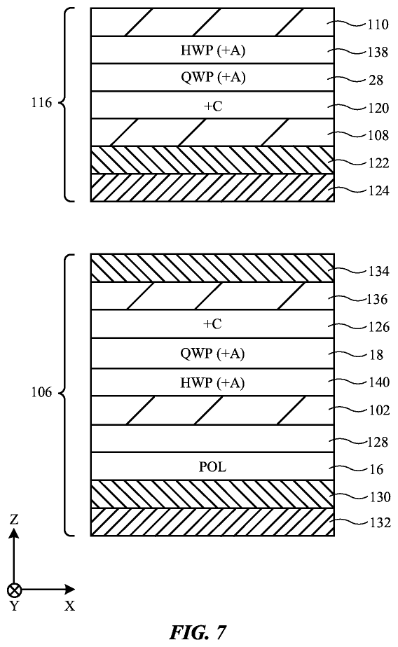

FIG. 7 shows an example where wave plate stack 116 includes a normal dispersion, positive birefringence +A quarter wave plate 28. The quarter wave plate 28 is a positive A-plate (sometimes referred to as +A plate 28, +A QWP 28, etc.). The wave plate stack 116 also includes a normal dispersion half wave plate (HWP) 138. The half wave plate 138 is a positive A-plate (e.g., the half wave plate has positive birefringence).

In addition to QWP 28 and HWP 138, wave plate stack 116 includes a positive C-plate 120 (sometimes referred to as +C plate, posi-C plate, etc.). The +C plate 120 in FIG. 7 compensates for the viewing angle dependence of quarter wave plate 28. By including the +C plate, the display has more brightness and color uniformity across viewing angles.

The polarizer stack 106, meanwhile, includes a normal dispersion quarter wave plate that is a positive A-plate (sometimes referred to as +A plate 18, +A QWP 18, etc.). QWP 18 has a positive birefringence. Polarizer stack 106 also includes a normal dispersion half wave plate (HWP) 140. The half wave plate 140 is a positive A-plate (e.g., the half wave plate has positive birefringence). In other words, QWP 28, QWP 18, HWP 138, and HWP 140 all have a birefringence of the same sign (type).

Similar to the wave plate stack 116, polarizer stack 106 also includes a positive C-plate 126 adjacent to quarter wave plate 18. The +C plate 126 in FIG. 7 compensates for the viewing angle dependence of quarter wave plate 18. By including the +C plate, the display has more brightness and color uniformity across viewing angles.

The optical axes of QWPs 18 and 28 as well as HWPs 138 and 140 may be selected such that the HWPs compensate for the QWPs. The optical axes of +A QWP 28 and +A QWP 18 may be orthogonal. The optical axes of +A HWP 138 and +A HWP 140 may be orthogonal. The angles of the optical axes relative to the absorption axis of linear polarizer 16 may satisfy the equation |β−2α|=π/4, 3π/4, 5π/4, . . . where β is the angle of the optical axes of the QWP and a is the angle of the optical axes of the HWP. In one example, QWP 28 has an optical axis at an angle of −15 degrees relative to the absorption axis of linear polarizer 16, HWP 138 has an optical axis at an angle of −75 degrees relative to the absorption axis of linear polarizer 16, QWP 18 has an optical axis at an angle of +75 degrees relative to the absorption axis of linear polarizer 16, and HWP 140 has an optical axis at an angle of +15 degrees relative to the absorption axis of linear polarizer 16. Using these angles satisfies the aforementioned equation (e.g., abs(+75°−2*(+15°))=45°=π/4 and abs(−15°−2*(−75°))=135°=3π/4).

In FIG. 7, +A QWP 28, +A HWP 138, and +C plate 120 are interposed between adhesive layer 108 and adhesive layer 110. Substrate 122 is included adjacent to adhesive layer 108. A hard coating 124 is also included, with substrate 122 interposed between adhesive layer 108 and hard coating 124.

In display polarizer stack 106, +C plate 126, +A QWP 18, and +A HWP 140 are interposed between adhesive layers 102 and 136. Compensating layer(s) 128 are included between adhesive layer 102 and linear polarizer 16. Adhesive layer 136 is interposed between +C plate 126 and substrate 134. Substrate 130 is also included adjacent to polarizer 16. A hard coating 132 is also included, with substrate 130 interposed between polarizer 16 and hard coating 132.

A wave plate arrangement of the type shown in FIG. 7 may provide broadband performance. The examples of wave plate stack 116 and polarizer stack 106 in FIG. 7 are merely illustrative. In general, various layers (e.g., adhesive layers, hard coatings, substrates, compensating layers, etc.) may be omitted or added to the stacks as desired.

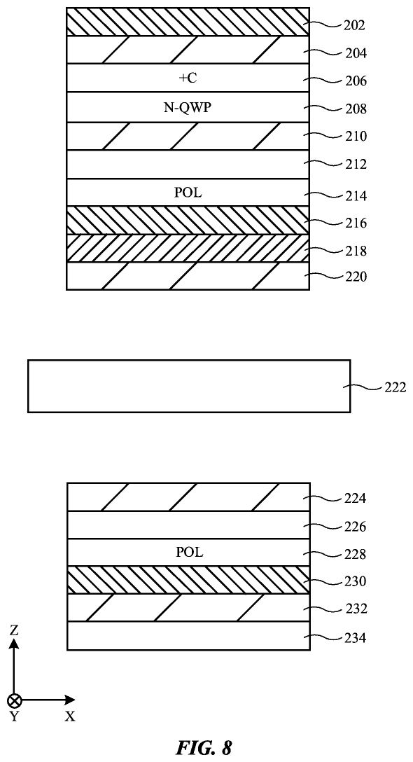

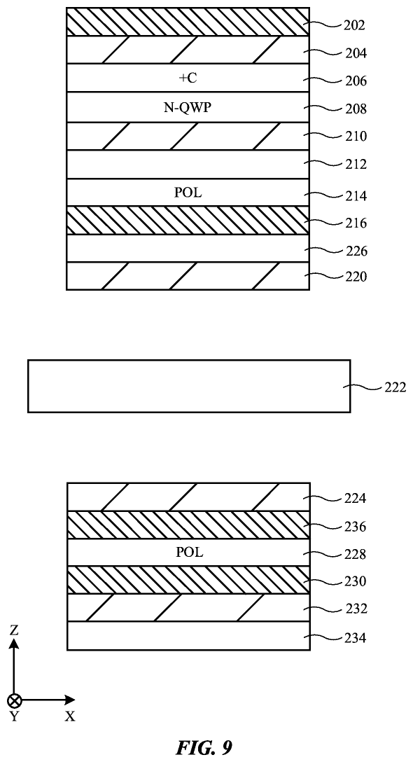

The arrangements of FIGS. 2-7 may be used with an array of OLED display pixels or any other type of display pixels. In some cases, display system 40 may include liquid crystal display pixels. In this type of arrangement, a liquid crystal display panel is interposed between first and second linear polarizers. Arrangements for display systems with liquid crystal display panels are shown in FIGS. 8 and 9.

As shown in FIG. 8, a liquid crystal display panel 222 is interposed between first and second stacks of optical layers. Specifically, liquid crystal display panel 222 is interposed between a first (front) linear polarizer 214 and a second (rear) linear polarizer 228. The first and second linear polarizers 214 and 228 may have orthogonal absorption axes (and therefore orthogonal pass axes). The liquid crystal display panel 222 may have a plurality of individually controllable pixels. Each pixel may selectively rotate or not rotate the polarization of linearly polarized incoming light received from polarizer 228 (e.g., light travelling in the positive Z-direction from a light source such as backlight). Light with a polarization that is not rotated will be absorbed by linear polarizer 214. Light with a polarization that is rotated will pass through linear polarizer 214. In this way, the liquid crystal display panel 222 may control the brightness of each pixel.

Polarizer 228 (sometimes referred to as a rear polarizer) is formed over substrate 230 and an adhesive layer 232. Substrate 230 may be formed from a polymer material such as triacetyl cellulose (TAC) or any other desired material. Adhesive layer 232 may be interposed between substrate 230 and a light recycling layer 234. The light recycling layer 234 may transmit light of a first polarization and reflect light of a second polarization in order to recycle light and improve efficiency in the display. One or more compensating layers 226 is interposed between polarizer 228 and adhesive layer 224. Compensating layer(s) 226 may perform polarization compensation for the display system.

Polarizer 214 is formed over a substrate 216, a hard coating 218, and an adhesive layer 220. One or more compensating layers 212 may be formed over polarizer 214. Compensating layer(s) 212 may perform polarization compensation for the display system. A negative dispersion quarter wave plate (N-QWP) 208 may also be formed over linear polarizer 214. An adhesive layer 210 attaches QWP 208 to compensating layer 212. A positive C-plate 206 is formed adjacent to QWP 208. An adhesive layer 204 is interposed between C-plate 206 and substrate 202. Substrates 202 and 216 may be formed from a polymer material such as triacetyl cellulose (TAC) or any other desired material.

QWP 208 may have an optical axis that is at a 45 degree angle relative to the absorption axis of polarizer 214. The display system therefore emits circularly polarized light. The +C plate 206 in FIG. 8 compensates for the viewing angle dependence of quarter wave plate 208. By including the +C plate, the display has more brightness and color uniformity across viewing angles.

The example of including a +C plate and a N-QWP above the front polarizer 214 of a liquid crystal display panel is merely illustrative. If desired, other wave plate arrangements may be used in liquid crystal displays (e.g., the −A QWP of FIG. 5, the +A HWP an −A QWP of FIG. 6, the +A HWP and +A QWP of FIG. 7, etc.). The optical system may have a wave plate arrangement that corresponds to the wave plate arrangement used in the display (e.g., as shown in FIGS. 4-7).

In FIG. 8, a first compensating layer 226 is formed between polarizer 228 and liquid crystal display panel. A second compensating layer 212 is formed above polarizer 214. This example is merely illustrative. In another possible arrangement, shown in FIG. 9, the compensating layer 226 may be moved to between the liquid crystal display panel 222 and the front polarizer 214. The compensating layer 226 is interposed between substrate 216 and adhesive layer 220 in FIG. 9. Above the rear polarizer, a substrate 236 may be interposed between adhesive layer 224 and polarizer 228 (to take the place of compensating layer 226). Substrate 236 may be formed from a polymer material such as triacetyl cellulose (TAC) or any other desired material.

In the aforementioned examples of FIGS. 4-9, each wave plate (e.g., QWPs and HWP) may be formed from a film, a liquid crystal layer, or any other desired material. Each polarizer may be formed from a coating or as a stretched polarizer (e.g., formed from polyvinyl alcohol doped with iodine).

In accordance with an embodiment, an electronic device is provided that includes a display system configured to produce light, the display system includes an array of display pixels configured to produce the light; a linear polarizer that is formed over the array of display pixels; and a first negative dispersion quarter wave plate that is formed over the linear polarizer; and a lens module that receives the light from the display system, the lens module includes a lens element having a convex surface and a concave surface; a partially reflective mirror that is interposed between the lens element and the display system; and a second negative dispersion quarter wave plate, the lens element is interposed between the partially reflective mirror and the second negative dispersion quarter wave plate.

In accordance with another embodiment, the lens module includes a reflective polarizer, the second negative dispersion quarter wave plate is formed between the reflective polarizer and the lens element.

In accordance with another embodiment, the lens module includes an additional linear polarizer, the reflective polarizer is interposed between the second negative dispersion quarter wave plate and the additional linear polarizer.

In accordance with another embodiment, the reflective polarizer has a pass axis and a reflection axis that is orthogonal to the pass axis.

In accordance with another embodiment, the additional linear polarizer has a pass axis that is parallel to the pass axis of the reflective polarizer.

In accordance with another embodiment, the reflection axis of the reflective polarizer is perpendicular to an absorption axis of the linear polarizer.

In accordance with another embodiment, the electronic device includes a first positive C-plate that is adjacent to the first negative dispersion quarter wave plate; and a second positive C-plate that is adjacent to the second negative dispersion quarter wave plate.

In accordance with another embodiment, the first negative dispersion quarter wave plate has a first optical axis and the second negative dispersion quarter wave plate has a second optical axis that is orthogonal to the first optical axis.

In accordance with an embodiment, an electronic device is provided that includes a display system configured to produce light, the display system includes an array of display pixels configured to produce the light; a linear polarizer that is formed over the array of display pixels; and a first quarter wave plate that is formed over the linear polarizer, the first quarter wave plate is an A-plate having a negative birefringence; and a lens module that receives the light from the display system, the lens module includes a lens element having a convex surface and a concave surface; a partially reflective mirror that is interposed between the lens element and the display system; and a second quarter wave plate, the lens element is interposed between the partially reflective mirror and the second quarter wave plate and the second quarter wave plate is an A-plate having a positive birefringence.

In accordance with another embodiment, the first quarter wave plate has a first optical axis and the second quarter wave plate has a second optical axis that is parallel to the first optical axis.

In accordance with another embodiment, the lens module includes a reflective polarizer, the second quarter wave plate is formed between the reflective polarizer and the lens element.

In accordance with another embodiment, the lens module includes an additional linear polarizer, the reflective polarizer is interposed between the second quarter wave plate and the additional linear polarizer.

In accordance with another embodiment, the reflective polarizer has a pass axis and a reflection axis that is orthogonal to the pass axis.

In accordance with an embodiment, an electronic device is provided that includes a display system configured to produce light, the display system includes an array of display pixels configured to produce the light; a linear polarizer that is formed over the array of display pixels; a first quarter wave plate that is formed over the linear polarizer; and a first half wave plate that is formed over the linear polarizer; and a lens module that receives the light from the display system, the lens module includes a lens element having a convex surface and a concave surface; a partially reflective mirror that is interposed between the lens element and the display system; a second quarter wave plate, the lens element is interposed between the partially reflective mirror and the second quarter wave plate; and a second half wave plate, the lens element is interposed between the partially reflective mirror and the second half wave plate.

In accordance with another embodiment, the first quarter wave plate has a negative birefringence and the first half wave plate has a positive birefringence.

In accordance with another embodiment, the second quarter wave plate has a positive birefringence and the second half wave plate has a negative birefringence.

In accordance with another embodiment, the first quarter wave plate has a first optical axis, the second quarter wave plate has a second optical axis that is parallel to the first optical axis, the first half wave plate has a third optical axis, the second half wave plate has a fourth optical axis that is parallel to the third optical axis.

In accordance with another embodiment, the first quarter wave plate has a positive birefringence and the first half wave plate has a positive birefringence.

In accordance with another embodiment, the second quarter wave plate has a positive birefringence and the second half wave plate has a positive birefringence.

In accordance with another embodiment, the first quarter wave plate has a first optical axis, the second quarter wave plate has a second optical axis that is perpendicular to the first optical axis, the first half wave plate has a third optical axis, the second half wave plate has a fourth optical axis that is perpendicular to the third optical axis.

In accordance with another embodiment, the electronic device includes a first positive C-plate that is adjacent to the first quarter wave plate; and a second positive C-plate that is adjacent to the second quarter wave plate.

The foregoing is merely illustrative and various modifications can be made to the described embodiments. The foregoing embodiments may be implemented individually or in any combination.

What is claimed is:

1. An electronic device comprising:
a display system configured to produce light, wherein the display system comprises:
an array of display pixels configured to produce the light;
a linear polarizer that is formed over the array of display pixels; and
a first negative dispersion quarter wave plate that is formed over the linear polarizer; and
a lens module that receives the light from the display system, wherein the lens module comprises:
a lens element having a convex surface and a concave surface;
a partially reflective mirror that is interposed between the lens element and the display system; and
a second negative dispersion quarter wave plate, wherein the lens element is interposed between the partially reflective mirror and the second negative dispersion quarter wave plate.

2. The electronic device defined in claim 1, wherein the lens module further comprises:
a reflective polarizer, wherein the second negative dispersion quarter wave plate is formed between the reflective polarizer and the lens element.

3. The electronic device defined in claim 2, wherein the lens module further comprises:
an additional linear polarizer, wherein the reflective polarizer is interposed between the second negative dispersion quarter wave plate and the additional linear polarizer.

4. The electronic device defined in claim 3, wherein the reflective polarizer has a pass axis and a reflection axis that is orthogonal to the pass axis.

5. The electronic device defined in claim 4, wherein the additional linear polarizer has a pass axis that is parallel to the pass axis of the reflective polarizer.

6. The electronic device defined in claim 4, wherein the reflection axis of the reflective polarizer is perpendicular to an absorption axis of the linear polarizer.

7. The electronic device defined in claim 1, further comprising:
a first positive C-plate that is adjacent to the first negative dispersion quarter wave plate; and
a second positive C-plate that is adjacent to the second negative dispersion quarter wave plate.

8. The electronic device defined in claim 1, wherein the first negative dispersion quarter wave plate has a first optical axis and wherein the second negative dispersion quarter wave plate has a second optical axis that is orthogonal to the first optical axis.

9. A electronic device comprising:
a display system configured to produce light, wherein the display system comprises:
an array of display pixels configured to produce the light;
a linear polarizer that is formed over the array of display pixels; and
a first quarter wave plate that is formed over the linear polarizer, wherein the first quarter wave plate is an A-plate having a negative birefringence; and
a lens module that receives the light from the display system, wherein the lens module comprises:
a lens element having a convex surface and a concave surface;
a partially reflective mirror that is interposed between the lens element and the display system; and
a second quarter wave plate, wherein the lens element is interposed between the partially reflective mirror and the second quarter wave plate and wherein the second quarter wave plate is an A-plate having a positive birefringence.

10. The electronic device defined in claim 9, wherein the first quarter wave plate has a first optical axis and wherein the second quarter wave plate has a second optical axis that is parallel to the first optical axis.

11. The electronic device defined in claim 9, wherein the lens module further comprises:
a reflective polarizer, wherein the second quarter wave plate is formed between the reflective polarizer and the lens element.

12. The electronic device defined in claim 11, wherein the lens module further comprises:
an additional linear polarizer, wherein the reflective polarizer is interposed between the second quarter wave plate and the additional linear polarizer.

13. The electronic device defined in claim 11, wherein the reflective polarizer has a pass axis and a reflection axis that is orthogonal to the pass axis.

14. A electronic device comprising:
a display system configured to produce light, wherein the display system comprises:
an array of display pixels configured to produce the light;
a linear polarizer that is formed over the array of display pixels;
a first quarter wave plate that is formed over the linear polarizer; and
a first half wave plate that is formed over the linear polarizer; and
a lens module that receives the light from the display system, wherein the lens module comprises:
a lens element having a convex surface and a concave surface;
a partially reflective mirror that is interposed between the lens element and the display system;
a second quarter wave plate, wherein the lens element is interposed between the partially reflective mirror and the second quarter wave plate; and
a second half wave plate, wherein the lens element is interposed between the partially reflective mirror and the second half wave plate.

15. The electronic device defined in claim 14, wherein the first quarter wave plate has a negative birefringence and the first half wave plate has a positive birefringence.

16. The electronic device defined in claim 15, wherein the second quarter wave plate has a positive birefringence and the second half wave plate has a negative birefringence.

17. The electronic device defined in claim 16, wherein the first quarter wave plate has a first optical axis, wherein the second quarter wave plate has a second optical axis that is parallel to the first optical axis, wherein the first half wave plate has a third optical axis, wherein the second half wave plate has a fourth optical axis that is parallel to the third optical axis.

18. The electronic device defined in claim 14, wherein the first quarter wave plate has a positive birefringence and the first half wave plate has a positive birefringence.

19. The electronic device defined in claim 18, wherein the second quarter wave plate has a positive birefringence and the second half wave plate has a positive birefringence.

20. The electronic device defined in claim 19, wherein the first quarter wave plate has a first optical axis, wherein the second quarter wave plate has a second optical axis that is perpendicular to the first optical axis, wherein the first half wave plate has a third optical axis, wherein the second half wave plate has a fourth optical axis that is perpendicular to the third optical axis.

21. The electronic device defined in claim 14, further comprising:
a first positive C-plate that is adjacent to the first quarter wave plate; and
a second positive C-plate that is adjacent to the second quarter wave plate.
